(19) United States
(12) Patent Application Publication
(10) Pub. No.: US 2006/0168440 A1
(43) Pub. Date: Jul. 27, 2006

(54) OS selection methods and computer systems utilizing the same

(75) Inventor: Jiun Jeng Huang, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Lite-On Technology Corporation

(21) Appl. No.: 11/165,208

(22) Filed: Jun. 23, 2005

(30) Foreign Application Priority Data
Jan. 24, 2005 (TW) 94101982

(51) Int. Cl. G06F 9/24; G06F 15/177; G06F 9/445; G06F 9/00

(52) U.S. Cl. 713/2

(57) ABSTRACT

OS (Operating system) selection methods and computer system utilizing the same. A tag is provided in a storage device of a computer system. The tag is used to determine the OS used by the computer system. When the computer system boots, a master boot program checks the tag. If the tag is a first value, a first OS is loaded on the computer system, enabling the computer system to enter media mode. If the tag is a second value, a second OS is loaded on the computer system, enabling the computer system to enter PC mode. After the computer system enters PC mode and requires entry into media mode, the tag is set to the first value, and the computer system reboots.

### BACKGROUND

The present disclosure relates generally to computer management, and, more particularly, to methods and computer systems that operate and switch OSs (Operating Systems).

In addition to a PC mode, a media mode can be also activated in computer systems. In PC mode, general operations of a personal computer are available. In media mode, playback and recording on discs or mp3, recording of PVR, and use of IR remote controllers can be executed.

Respective operating modes must have corresponding OSs. In different computer system designs, respective OSs are stored in respective storage devices, in respective disk partitions of one storage device, or in a single disk partition of a storage device, in which the image of an OS is embedded in the file system of another OS.

Conventionally, OS selection is performed using a multi-OS loader, or via a master boot program with code rewriting and correction. The master boot program, however, is a critical and important component of a computer system. If abnormal interruptions or power failures occur during code rewriting and correction, the master boot program may be destroyed, resulting in boot failure of the computer system.

Taiwanese Patent No. 586714 discloses a computer system capable of operating in multiple operating modes, and operating methods therefor. The computer system comprises a disk storage device having a first disk partition and a second disk partition. A mode controller enables the computer system to switch between available operating modes. The computer system employs the master boot program to check the state of the mode controller, and set a corresponding operating mode accordingly. There, since the mode controller is an additional component, the cost of computer system is increased.

Additionally, in a computer system using a file system to manage multiple OSs, the OS image must be decompressed and expanded prior to execution. Since these operations are performed in a system memory of the computer system, the expanded OS and data are lost after the computer system powers off or reboots. No efficient mechanism is provided for OS selection in this computer system design.

OS selection methods and computer systems utilizing the same are provided.

In an embodiment of an OS selection method, a tag is provided in a storage device of a computer system. The tag is used to determine an OS used by the computer system. When the computer system boots, a master boot program checks the tag. If the tag is a first value, a first OS is loaded on the computer system. If the tag is a second value, a second OS is loaded on the computer system, enabling the computer system to enter PC mode.

If the tag is the first value, an image of the first OS is decompressed and expanded to load the first OS on the computer system, enabling the computer system to enter media mode. After the computer system enters media mode and requires entry into PC mode, the tag is set to the second value, and the computer system reboots.

After the computer system enters PC mode and requires entry into media mode, the tag is set to the first value, and the computer system reboots.

An embodiment of a computer system comprises a storage device and a master boot program. The storage device comprises a tag used to determine an OS used by the computer system. The master boot program checks the tag. If the tag is a first value, a first OS is loaded on the computer system. If the tag is a second value, a second OS is loaded on the computer system, enabling the computer system to enter PC mode.

If the tag is the first value, an image of the first OS is decompressed and expanded to load the first OS on the computer system, enabling the computer system to enter media mode. After the computer system enters media mode and requires entry into PC mode, the tag is set to the second value, and the computer system reboots.

After the computer system enters PC mode and requires entry into media mode, the tag is set to the first value, and the computer system reboots.

OS selection methods may take the form of program code embodied in tangible media. When the program code is loaded into and executed by a machine, the machine becomes an apparatus for practicing the disclosed method.

### DESCRIPTION OF THE DRAWINGS

The invention will become more fully understood by referring to the following detailed description with reference to the accompanying drawings, wherein:

FIG. 1 is a schematic diagram illustrating an embodiment of a computer system;

FIG. 2 is a schematic diagram illustrating an embodiment of a storage device in the computer system;

FIG. 3 is a flowchart of an embodiment of an OS selection method; and

FIG. 4 is a flowchart of another embodiment of an OS selection method.

### DESCRIPTION

OS selection methods and computer systems utilizing the same are provided.

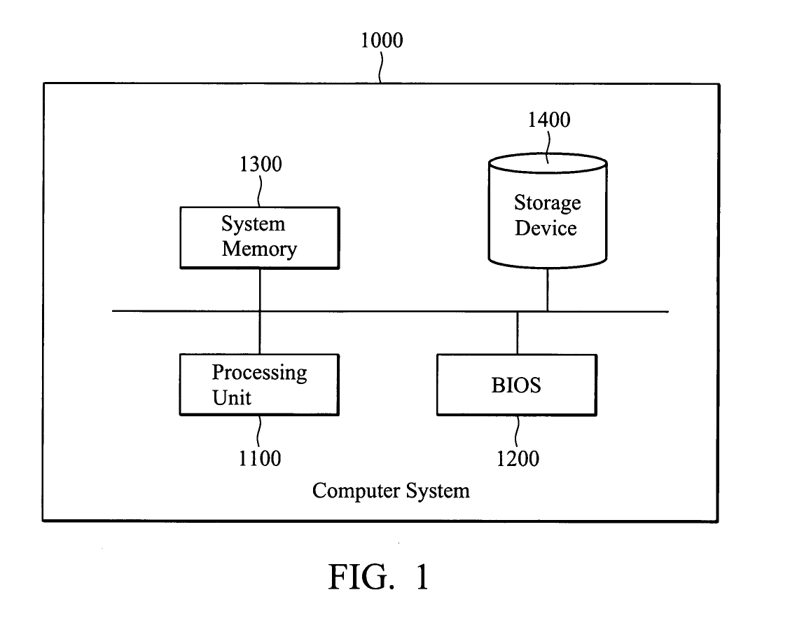

FIG. 1 is a schematic diagram illustrating an embodiment of a computer system.

The computer system 1000 comprises a processing unit 1100, a BIOS (Basic Input/Output System) 1200, a system memory 1300, and a storage device 1400. The processing unit 1100 performs related operations, such as OS selection procedures for the computer system 1000. The BIOS 1200 provides basic functions to the computer systems, such as input and output, configuration, and POST (Power On Self Test) functions. The system memory 1300 may be a RAM (Random Access Memory) storing programs to be executed and related data required during operation of the computer system 1000. The storage device 1400 may be a hard disk.

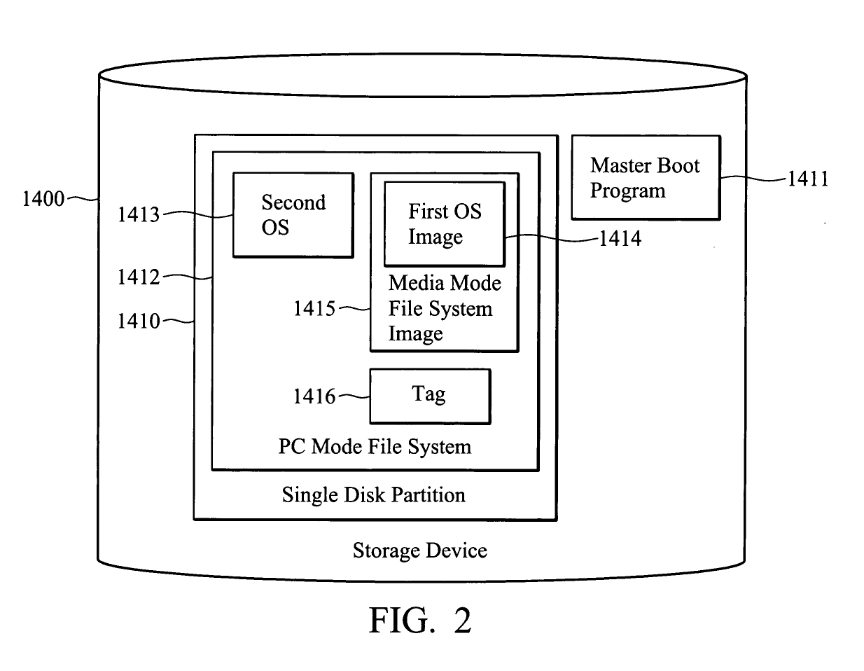

FIG. 2 is a schematic diagram illustrating an embodiment of a storage device in the computer system.

In this embodiment, the storage device 1400 comprises a single partition disk 1410 and a master boot program 1411. The single partition disk 1410 comprises a file system for PC mode 1412 comprising a second OS 1413, a file system image of media mode 1415 comprising a first OS image 1414, and a tag 1416.

The master boot program 1411 is loaded and executed from the BIOS 1200 to perform the boot procedure of the computer system 1000. When the computer system 1000 boots, the master boot program 1411 performs related determinations and enables the computer system 1000 to load a specific OS, enabling the computer system 1000 to enter a specific operating mode, such as PC mode or media mode. The file system of PC mode 1412 is, when in PC mode, such as Microsoft Windows NTFS or FAT32. The second OS 1413 is, when in PC mode, such as Microsoft Windows XP and others. The first OS image 1414 is an image, which can be decompressed and expanded as a first OS for execution in the system memory 1300. The first OS is, when in media mode, such as Microsoft Windows CE. The file system image of media mode 1415 is an image of a root file system, which can be decompressed and expanded as a file system for execution in the system memory 1300. The file system for media mode is, when in media mode, such as Ext2, Ext3, Minix, and others. The tag 1416 is used to determine an OS used by the computer system 1000. For example, if the tag 1416 is set to a first value, it represents the first OS is required to load on the computer system 1000. If the tag 1416 is set to a second value, it represents the second OS is required to load on the computer system 1000.

It is understood that the file system image of media mode 1415 is an image designed using Ramdisk technique. The related file system, applications, and system content corresponding to media mode can be placed in a ramdisk, and the ramdisk can be packed and compressed as an image. Additionally, since the storage device 1400 comprises a single partition, the first OS image 1414 and the file system image of media mode 1415 are embedded into the file system of PC mode 1412 as normal files.

While in these embodiments, various OSs are placed in the single disk partition of the storage device, the invention is not limited thereto. In some embodiments, various OSs can be stored in respective storage devices or in respective disk partitions of one storage device.

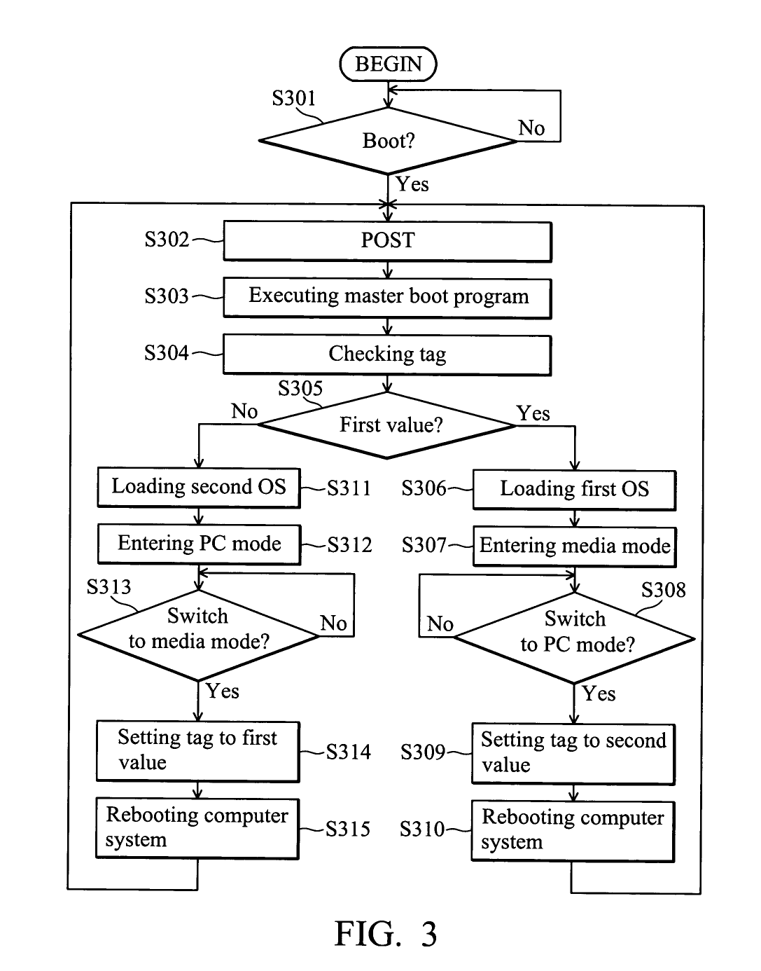

FIG. 3 is a flowchart of an embodiment of an OS selection method.

In step S301, it is determined whether the computer system 1000 has booted. If not, the procedure remains at step S301. If so (Yes in step S301), in step S302, the BIOS 1200 performs POST, and in step S303, executes the master boot program 1411. In step S304, the master boot program 1411 checks the tag 1416.

If the tag 1416 is a first value (Yes in step S305), in step S306, a first OS is loaded on the computer system 1000, and in step S307, the computer system 1000 is enabled to enter and operate in PC mode. In this embodiment, the loading of first OS is performed by first decompressing and expanding a first OS image to execute a first OS kernel on the computer system. Then, a ramdisk is established in the system memory 1300, and related initialization is performed. The file system image of media mode 1415 is decompressed and expanded in the ramdisk to install the file system of media mode on the computer system 1000. It is understood that since the file system image of media mode 1415 is an image designed using Ramdisk technique, the file system image of media mode can be launched in a Ramdisk method directly, such that the ramdisk initialization and image expansion are executed automatically. In step S308, it is determined whether the computer system requires switching to PC mode (using the second OS). If not (No in step S308), the procedure remains at step S308. If so (Yes in step S308), in step S309, the first OS sets the tag 1416 to the second value. In step S310, the computer system 1000 reboots.

If the tag is not the first value (No in step S305), in step S311, the second OS 1413 is loaded on the computer system 1000, and in step S312, the computer system 1000 is enabled to enter and operate in PC mode. In step S313, it is determined whether the computer system requires switching to media mode (using the first OS). If not (No in step S313), the procedure remains at step S313. If so (Yes in step S313), in step S314, the second OS 1413 sets the tag 1416 to the first value. In step S315, the computer system 1000 reboots.

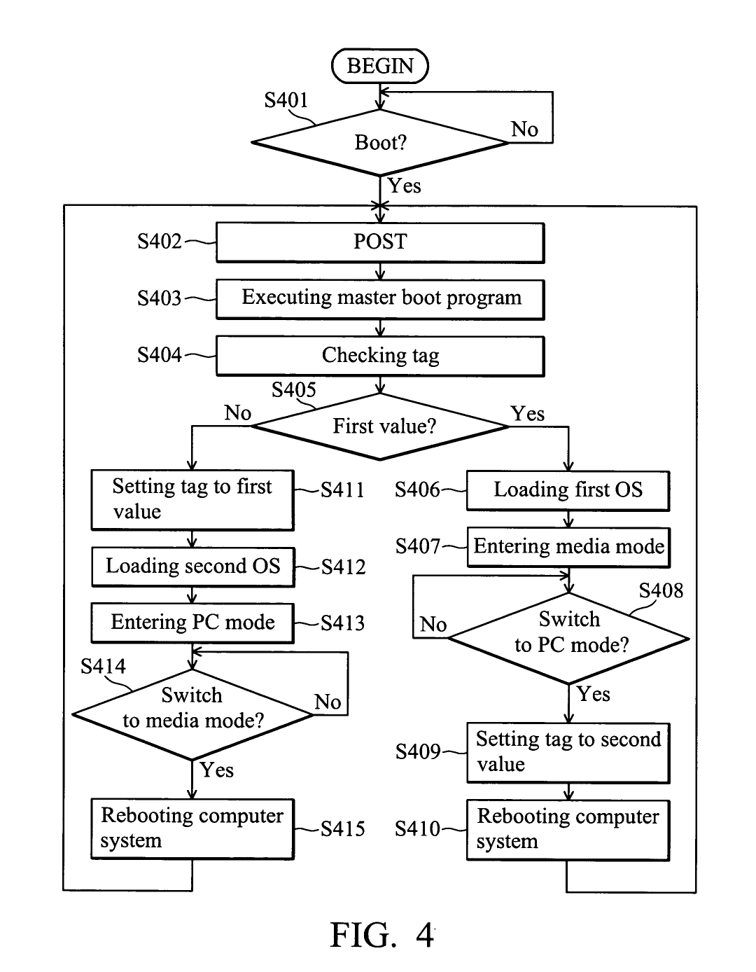

FIG. 4 is a flowchart of another embodiment of an OS selection method. In this embodiment, the default operating mode of the computer system 1000 is set as media mode. That is the computer system 1000 returns to media mode after the computer system 1000 completes the operations in PC mode and reboots.

In step S401, it is determined whether the computer system 1000 has booted. If not, the procedure remains at step S401. If so (Yes in step S401), in step S402, the BIOS 1200 performs POST, and in step S403, executes the master boot program 1411. In step S404, the master boot program 1411 checks the tag 1416.

If the tag 1416 is a first value (Yes in step S405), in step S406, a first OS is loaded on the computer system 1000, and in step S407, the computer system 1000 is enabled to enter and operate in PC mode. Similarly, loading of the first OS is performed by first decompressing and expanding a first OS image to execute a first OS kernel on the computer system. Then, a ramdisk is established in the system memory 1300, and related initialization is performed. The file system image of media mode 1415 is decompressed and expanded in the ramdisk to install the file system of media mode on the computer system 1000. In step S408, it is determined whether the computer system requires switching to PC mode (using the second OS). If not (No in step S408), the procedure remains at step S408. If so (Yes in step S408), in step S409, the first OS sets the tag 1416 to the second value. In step S410, the computer system 1000 reboots.

If the tag is not the first value (No in step S405), in step S411, the tag 1416 is automatically set to the first value. Note that, after the tag 1416 is set to the first value, the computer system 1000 will automatically enter media mode after rebooting. In step S412, the second OS 1413 is loaded on the computer system 1000, and in step S413, the computer system 1000 is enabled to enter and operate in PC mode. In step S414, it is determined whether the computer system requires switching to media mode. If not (No in step S414), the computer system 1000 still operates in PC mode, and the procedure remains at step S414. If so (Yes in step S414), in step S415, the computer system 1000 reboots. It is understood that, while two values are disclosed in these embodiments, the invention is not limited thereto. The number of values can be dynamically extended according to the number of OSs. In the invention, the computer system can load or operate in different OSs according to the tag setting.

OS selection methods, or certain aspects or portions thereof, may take the form of program code (i.e., executable instructions) embodied in tangible media, such as products, floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An OS selection method, comprising:
providing a tag in a storage device of a computer system, in which the tag is used to determine an OS used by the computer system;
when the computer system boots, checking of the tag by a master boot program;
if the tag is a first value, loading a first OS on the computer system; and
if the tag is a second value, loading a second OS on the computer system, enabling the computer system to enter PC mode.

2. The method of claim 1, further comprising if the tag is the first value, decompressing and expanding a first OS image to load the first OS on the computer system, enabling the computer system to enter media mode.

3. The method of claim 2, further comprising, after the computer system enters media mode and requires entry into PC mode, setting the tag to the second value, and rebooting the computer system.

4. The method of claim 3 further comprising setting the tag to the first value after the computer system reboots and enters PC mode.

5. The method of claim 1, further comprising, after the computer system enters PC mode and requires entry into media mode, setting the tag to the first value, and rebooting the computer system.

6. The method of claim 2 wherein the storage device comprises a single disk partition, and the tag, the second OS, and the first OS image are stored therein.

7. A computer system, comprising:
a tag used to determine an OS used by the computer system; and
a master boot program checking the tag, loading a first OS on the computer system if the tag is a first value, and loading a second OS on the computer system and enabling the computer system to enter PC mode if the tag is a second value.

8. The computer system of claim 7, wherein if the tag is the first value, the master boot program decompresses and expands a first OS image to load the first OS on the computer system, enabling the computer system to enter media mode.

9. The computer system of claim 8, wherein after the computer system enters media mode and requires entry into PC mode, the first OS further sets the tag to the second value, and reboots the computer system.

10. The computer system of claim 9 wherein the master boot program further sets the tag to the first value after the computer system reboots and enters PC mode.

11. The computer system of claim 7, wherein after the computer system enters PC mode and requires entry into media mode, the second OS further sets the tag to the first value, and reboots the computer system.

12. The computer system of claim 8 wherein the tag is stored in a storage device.

13. The computer system of claim 12 wherein the storage device comprises a single disk partition, and the tag, the second OS, and the first OS image are stored therein.

14. An OS selection method, comprising:
providing a tag in a storage device of a computer system;
when the computer system boots, checking of the tag by a master boot program; and
loading an OS on the computer system according to the tag.
